(19) United States
(12) Patent Application Publication
(10) Pub. No.: US 2015/0261748 A1
(43) Pub. Date: Sep. 17, 2015

(54) Web Service Workflow Chains for Processing Objects

(71) Applicant: Sharp Laboratories of America, Inc., Camas, WA (US)

(72) Inventors: Swee Huat Sng, Torrance, CA (US); Lena Sojian, Fountain Valley, CA (US)

(73) Assignee: Sharp Laboratories of America, Inc., Camas, WA (US)

(21) Appl. No.: 14/214,989

(22) Filed: Mar. 16, 2014

(51) Int. Cl. G06F 17/30; G06F 3/0482; H04L 29/08

(52) U.S. Cl. CPC G06F 17/30011; H04L 67/02; G06F 3/0482

(57) ABSTRACT

A method and system for invoking object processing web service workflow chains that are rapidly configurable and seamlessly executable. Rapid configuration and seamless execution are facilitated by a catalog of “reusable” object processing web services which adhere to a common service contract and can be integrated into workflow chains for processing objects as plug-and-play building blocks. The services in the workflow chains are provided references to locations of objects being processed (rather being given the objects themselves) to simplify and expedite execution. An exemplary workflow chain is composed of document imaging web services and is configured and executed in an MFP environment.

### BACKGROUND OF THE INVENTION

The present invention relates to improved web services integration and, more particularly, to improved web service integration in multifunction peripheral (MFP) environments.

Web services are specialized tasks performed by computing devices that are accessed using standard web communications protocols and published service contracts. Web services can be hosted on devices in a secure private network (e.g., enterprise network) or in a public network (e.g., cloud network).

Employing web services to perform specialized computing tasks can be highly advantageous. Web services allow complex tasks to be “farmed out” by an enterprise rather than internally developed, hosted and maintained. Relieving enterprises from implementation burdens associated with these complex tasks can save them substantial time and money. Moreover, since interactions with web services are governed by standard web communications protocols and published service contracts, enterprise computing devices can be configured to interact with computing devices offering web services with relative ease.

One class of enterprise computing device increasingly reliant on web services is the MFP. Some MFPs run applications that can invoke internally hosted document imaging web services (e.g., print, scan, fax, copy, etc.) as well as externally hosted document imaging web services [e.g., optical character recognition (OCR), document storage, document retrieval, image processing, etc.]. These MFP applications are often developed from scratch owing to the specific uses at which they are targeted and different programming languages used to code them. Likewise, MFP applications that combine more than one of these web services into a single workflow are often developed from scratch and can be highly complex due to varied service contracts to which the web services adhere.

### SUMMARY OF THE INVENTION

The present invention provides object processing web service workflow chains that are rapidly configurable and seamlessly executable. Rapid configuration and seamless execution are facilitated by a catalog of “reusable” object processing web services which adhere to a common service contract and can be integrated into workflow chains for processing objects as plug-and-play building blocks. The services in the workflow chains are provided references to locations of objects being processed (rather than being given the objects themselves) to simplify and expedite execution. Such a workflow chain may be composed of document imaging web services and may be configured and executed in an MFP environment. Alternatively, such a workflow chain may be composed of web services other than document imaging web services and may be configured and executed on or in conjunction with a computing device other than an MFP, such as a television, refrigerator, microwave, electronic advertising display panel, interactive presentation whiteboard or wireless handset.

In one aspect of the invention, a method for invoking a workflow chain of document imaging web services to process a document comprises providing a catalog of a plurality of document imaging web services individually classified as input services, input/output services or output services; constructing a workflow chain comprising a selected one of the input services, a selected one of the input/output services and a selected one of the output services; and executing the workflow chain whereby the selected input service stores a first document file reflecting application of the input service to the document, the selected input/output service is provided a first reference to a first storage location of the first document file, locates the first document file using the first reference and stores a second document file reflecting application of the input/output service to the document, and the selected output service is provided a second reference to a second storage location of the second document file, locates the second document file using the second reference and is applied to the document.

In some embodiments, the configuring step is performed using user selections made on a workflow construction menu displaying a plurality of user-selectable options for input services, input/output services and output services.

In some embodiments, the method further comprises determining whether a next one of the selected services is hosted on a different network than a current one of the selected services and moving a document file reflecting application of the current selected service to a storage location on the different network in response to determining that the next selected service is hosted on the different network.

In some embodiments, the current selected service is hosted on a secure private network and the next selected service is hosted on a public network.

In some embodiments, the current selected service is hosted on a public network and the next selected service is hosted on a secure private network.

In some embodiments, at least one of the selected services is hosted on an MFP and at least one of the selected services is hosted on a server remote from the MFP.

In some embodiments, the first and second references comprise Uniform Resource Locators (URLs).

In some embodiments, the cataloged input services comprise a document scanning service.

In some embodiments, the cataloged input services comprise a document retrieval service.

In some embodiments, the cataloged input/output services comprise an OCR service.

In some embodiments, the cataloged input/output services comprise a document preview service.

In some embodiments, the cataloged output services comprise a document printing service.

In some embodiments, the cataloged output services comprise a document storage service.

In some embodiments, the cataloged output services comprise a faxing service.

In another aspect of the invention, a system for invoking a workflow chain of document imaging web services to process a document comprises a workflow construction subsystem configured to provide a catalog of a plurality of imaging web services individually classified as input services, input/output services or output services and construct a workflow chain comprising a selected one of the input services, a selected one of the input/output services and a selected one of the output services; and a workflow execution subsystem operatively coupled with the workflow construction subsystem and configured to execute the workflow chain whereby the selected input service stores a first document file reflecting application of the input service to the document, the selected input/output service is provided a first reference to a first storage location of the first document file, locates the first document file using the first reference and stores a second document file reflecting application of the input/output service to the document, and the selected output service is provided a second reference to a second storage location of the second document file, locates the second document file using the second reference and is applied to the document.

In another aspect of the invention, a method for invoking a workflow chain of object processing web services to process an object comprises providing a catalog of a plurality of object processing web services individually classified as input services, input/output services or output services; constructing a workflow chain comprising a selected one of the input services, a selected one of the input/output services and a selected one of the output services; and executing the workflow chain whereby the selected input service stores a first object reflecting application of the input service, the selected input/output service is provided a first reference to a first storage location of the first object, locates the first object using the first reference and stores a second object reflecting application of the input/output service, and the selected output service is provided a second reference to a second storage location of the second object, locates the second object using the second reference and is applied to the second object.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a network architecture in which a system for invoking a workflow chain of document imaging web services is operative.

FIG. 2 shows an MFP operative in the network architecture.

FIG. 3 shows a workflow construction menu displaying user-selectable options for input services.

FIG. 4 shows a workflow construction menu displaying user-selectable options for input/output services.

FIG. 5 shows a workflow construction menu displaying user-selectable options for output services.

FIG. 6 shows a method for invoking a workflow chain of document imaging web services to process a document.

### DETAILED DESCRIPTION OF A PREFERRED EMBODIMENT

FIG. 1 shows a network architecture in which the present system for invoking a workflow chain of document imaging web services is operative in some embodiments. The network architecture includes an internal network 100 and an external network 140. Internal network 100 is a private network, such as an enterprise network, having a firewall 130 restricting access to internal network 100 by devices outside of internal network 100. External network 140 is a public network, such as a cloud network.

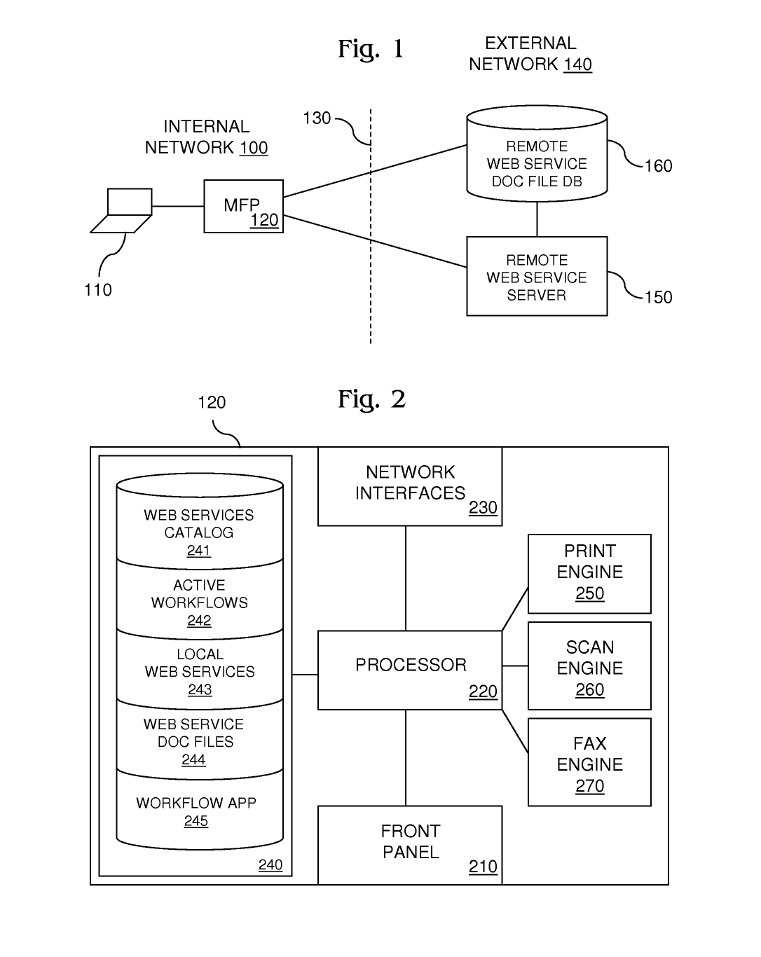

Internal network 100 has an MFP 120 and a local computer 110. MFP 120 is a computing and imaging device that participates in construction and execution of workflow chains of document imaging web services and also performs imaging functions. Turning to FIG. 2, MFP 120 has a front panel 210 for receiving inputs from walk-up users and displaying outputs to walk-up users. In some embodiments, front panel inputs are used in constructing the workflow chains. MFP 120 also has network interfaces 230. Network interfaces 230 include standard interfaces, such as universal serial bus (USB) ports and wired/wireless local area network (LAN) interfaces, which allow MFP 120 to communicate over wired or wireless network connections with other devices that participate in construction and execution of the workflow chains. In some embodiments, these participating devices include local computer 110, a remote web service server 150 and a remote web service document file database 160.

Within MFP 120, front panel 210 and network interfaces 230 are linked with a processor 220. Processor 220 is in turn linked with a local memory 240 and various imaging engines 250, 260, 270. Processor 220 executes programs installed in local memory 240 to conduct various operations on MFP 120. One of these programs is a workflow chain management application 245 that facilitates construction and execution of workflow chains of document imaging web services.

Local memory 240 is a data storage facility having various stores. One store retains a web services catalog 241. Web services catalog 241 includes service description documents for a plurality of document imaging web services that adhere to a common service contract and can be integrated in plug-and-play fashion into workflow chains of document imaging web services.

Each service description document includes the name of the document imaging web service which the document describes and a classification of the service as an input service, an input/output service or an output service. Document imaging web services that provide input to another document imaging web service in a workflow chain but do not receive output from another document imaging web service in the workflow chain are assigned to the input services class. Services that both receive output from another service and provide input to another service in a chain are assigned to the input/output service class. Services that receive output from another service but do not provide input to another service in a chain are assigned to the output service class. Accordingly, input services are adapted for placement at the start of a workflow chain, input/output services are adapted for placement in the middle of a chain and output services are adapted for placement at the end of a chain.

Each service description document also includes at least four defined URL endpoints used to invoke the document imaging web service. EndpointLoad is invoked to initialize and perform preparatory work required by the service before being called. EndpointRun is invoked to perform the main task provided by the service and also used to serve up a custom Hypertext Markup Language (HTML) graphical user interface if available. EndpointRunFinal is an optional endpoint that is invoked after EndpointRun and is used primarily for the HTML graphical user interface (if any) to submit user-selected options to the logic that performs the main task. EndpointDone is invoked to perform cleanup and other service termination procedures (e.g., free-up dynamic memory, erase temporary files, etc.). In some embodiments, there are a larger number of defined URL endpoints.

Another store in local memory 240 retains active workflows 242. Active workflows 242 are sequential lists of the document imaging web services in active workflow chains. These workflow chains are constructed based on user input provided on a workflow construction menu, programmatically by workflow chain management application 245, or some combination.

Another store in local memory 240 hosts local web services 243. Local web services 243 are locally hosted document imaging web services within web service catalog 241 that may be integrated into workflow chains and executed by processor 220.

Another store in local memory 240 retains web service document files 244. Web service document files 244 are produced by document imaging web services that are executed as part of workflow chains and reflect tasks performed by these web services.

Another store in local memory 240 retains workflow chain management application 245. Workflow chain management application 245 is a software or firmware program having instructions executable by processor 220.

Local memory 240 also retains other types of data, including other local programs executed by processor 220 to perform other operations on MFP 120.

Print engine 250 has printer logic, such as one or more integrated circuits, and an electromechanical printer section for performing printing functions. The electromechanical printer section may include, for example, a color ink jet head mounted on a movable carriage or a laser printing mechanism for printing images under the control of a printer integrated circuit.

Scan engine 260 has scanner logic, such as one or more integrated circuits, and an electromechanical scanner section for performing scanning functions. The electromechanical scanner section may include, for example, a line image sensor mounted on a movable carriage for optically scanning images under the control of a scanner integrated circuit and storing the scanned images in a local database in local memory 240.

Fax engine 270 has fax logic and an electromechanical fax section for performing facsimile functions.

MFP 120 may have additional imaging engines (not shown) supporting other imaging functions, such as copying and filing.

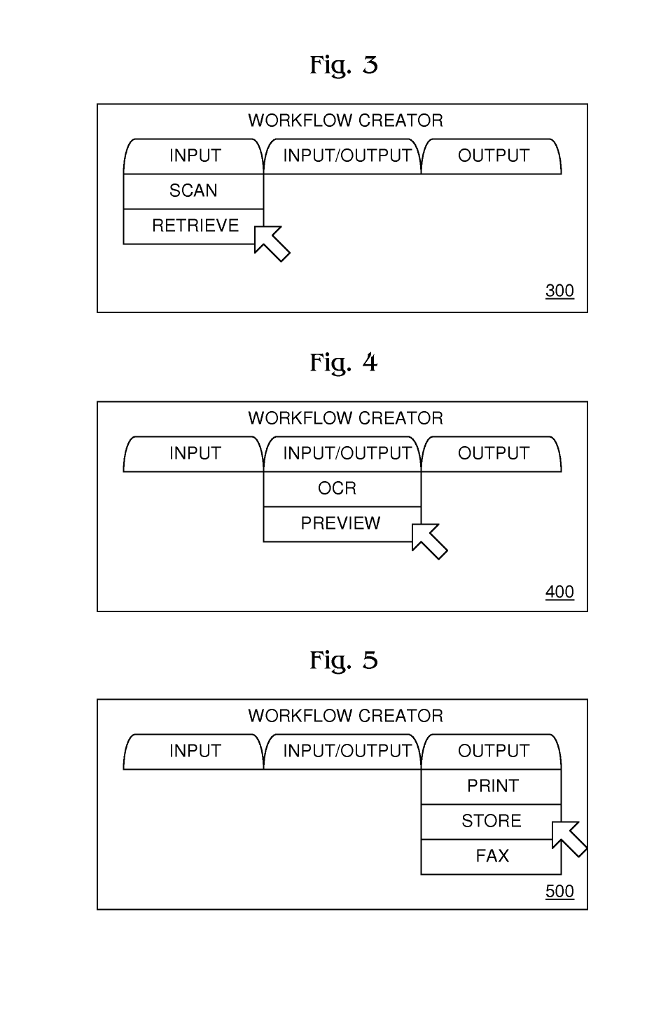

Local computer 110 is a computing device, such as a desktop, notebook or tablet computer or smart phone, that communicates with MFP 120 over a wired or wireless connection, such as a USB or wired or wireless LAN connection. In some embodiments, local computer 110 participates in workflow chain construction by displaying outputs to users, receiving inputs from users, and passing user inputs to MFP 120 which applies the user inputs in constructing workflow chains. For example, in FIGS. 3-5, workflow construction menu screens 300, 400, 500 displayed on local computer 110 are shown to have user-selectable options for input services, input/output services and output services, respectively. Workflow chain management application 245 imports these user-selectable options from web services catalog 241 into the workflow construction menu and sends the workflow construction menu to local computer 110 for display in a standard web browser or a client application. To construct a workflow chain from the menu, a user of local computer 110 first selects an input service (SCAN, RETRIEVE) from a pull-down tab entitled INPUT. Next, the user selects an input/output service (OCR, PREVIEW) from a pull-down tab entitled INPUT/OUTPUT. Then, the user selects an output service (PRINT, STORE, FAX) from a pull-down tab entitled OUTPUT. These user selections are relayed to MFP 120, which under the control of processor 220 executing workflow chain management application 245 constructs a workflow chain including the selected input service, input/output service and output service and stores the workflow chain in active workflows 242. In other embodiments, the workflow construction menu may be displayed and workflow chains may be constructed using user selections made on front panel 210. In still other embodiments, workflow chains may be constructed programmatically by workflow chain management application 245 without user input.

External network 140 includes remote web service server 150 and remote web service document file database 160.

Remote web service server 150 is a computing device that participates in workflow chain execution in some embodiments. Remote web service server 150 hosts and executes one or more remote document imaging web services within web services catalog 241 that may be integrated into workflow chains.

Remote web services document file database 160 is a storage facility retaining document files reflecting performance of tasks by document imaging web services in workflow chains.

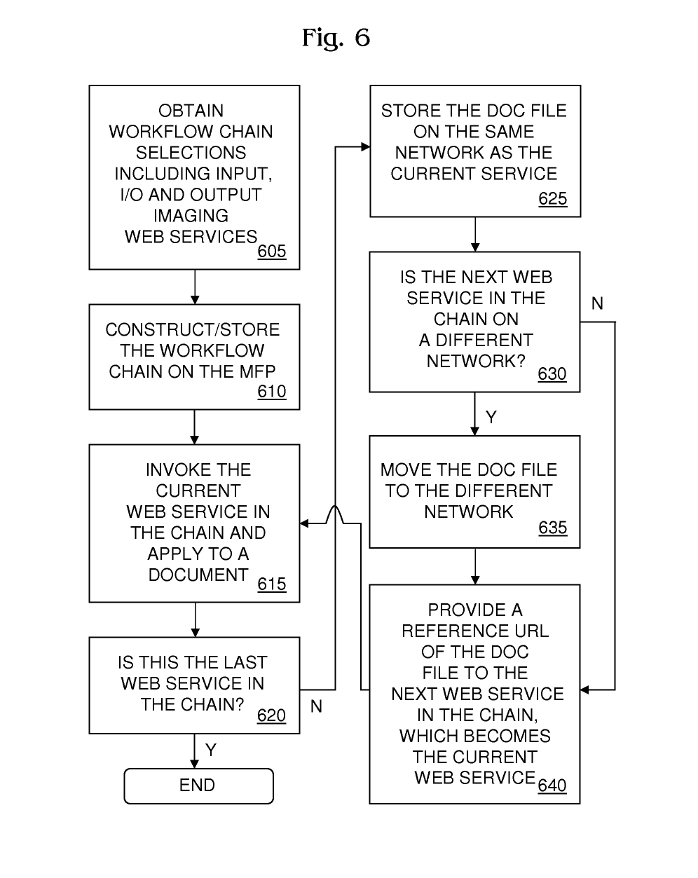

FIG. 6 shows a method for invoking a workflow chain of document imaging web services to process a document. In the method, an input service in the workflow chain produces and makes accessible to an input/output service in the chain a first document file reflecting application of the input service to a document, whereupon the input/output service accesses the first document file, produces a second document file reflecting application of the input/output service to the document and makes the second document file accessible to the next service in the chain, and so on if there are more services in the chain. Generally speaking, each document imaging web service in a workflow chain might be thought of as a filter that performs a specific type of processing on a document before handing it off to the next service in the chain.

At the outset, MFP 120 obtains selections of document imaging web services to be included in a workflow chain, including an input service, one or more input/output services and an output service (605). In some embodiments, these selections are made by a user through interaction with a workflow construction menu displayed on local computer 110 or front panel 210 under control of workflow chain management application 245 executing on processor 220. In other embodiments, these selections are made programmatically without user input by workflow chain management application 245 running on processor 220.

Next, MFP 120 constructs and stores the workflow chain on MFP 120 (610). Workflow chain management application 245 creates a sequential list of the selected services including the selected input service, followed by the one or more selected input/output services, followed by the selected output service and stores the sequential list to active workflows 242.

Next, MFP 120 invokes the current service in the workflow chain which applies the current service to the document (615). Workflow chain management application 245 consults the sequential list of services for the chain stored in active workflows 242 to obtain the name of the current service and uses the name to obtain the service description document for the current service from web services catalog 241. Application 245 then uses the defined URL endpoints from the service description document to invoke the current service, which applies the current service to the document. Document imaging web services are invoked through standard web communication protocols, such as SOAP (formerly Simple Object Access Protocol, now just SOAP) or Representational State Transfer (REST) layered on HTTP or HTTP Secure (HTTPS).

In the first iteration of the method, the current service is the input service and application of the current service may, for example, create a document file by scanning a paper document or retrieve a document file from remote storage. In the second iteration of the method, the current service is an input/output service and application of the current service may be, for example, perform OCR processing on a document image or create a thumbnail image for previewing a document image. In the third iteration of the method, the current service may be an output service and application of the current service may, for example, print a document from a document image, remotely store a document image or fax a document from a document image.

Where the current service is the last service in the workflow chain (i.e., the output service) (620), the workflow terminates. Workflow chain management application 245 consults the sequential list of services for the workflow chain stored in active workflows 242 to determine whether the current service is the last service in the chain.

Where the current service is not the last service in the workflow chain, the current service stores a document file reflecting application of the current service to the document on the same network as the current service (625). In this regard, if the current service is within local web services 243, the current service is executed locally by processor 220 and the document file reflecting application of the current service is stored to web service document files 244. On the other hand, if the current service is hosted on remote web services server 150, the current service is executed remotely by server 150 and the document file reflecting application of the current service is stored to remote web service output database 160. The document file stored by the current service may have the same or a different name and may be stored at the same or a different location than a document file processed by an earlier service in the workflow chain.

Next, MFP 120 checks whether the next service in the workflow chain is on a different network than the current service (630). In this check, workflow chain management application 245 consults the sequential list of services for the workflow chain stored in active workflows 242 to obtain the name of the next service and uses the name to obtain the service description document for the next service from web services catalog 241. Application 245 then compares location information for the next service from the service description with the known location of the current service.

Where the next service in the workflow chain is on a different network than the current service, MFP 120 moves the document file to the network where the next service is hosted (635). In this regard, if the current service is within local web services 243, the current service initially stores the document file within web service document files 244, which is on internal network 100. However, if the next service is hosted on remote web services server 150, which is on external network 140, firewall 130 could prevent the next service from accessing the document file as required to provide its service. Moreover, requiring the next service to access the document file remotely in order to perform its service is generally inefficient. Accordingly, workflow chain management application 245 moves the document file (through Hypertext Transfer protocol, HTTP) from web service document files 244 to remote web service output database 160 before invoking the next service. Conversely, if the current service is hosted on remote web services server 150 and the next service is within local web services 243, workflow chain management application 245 moves the document file from remote web service document file database 160 to web service document files 244 before invoking the next service.

Where the next service in the workflow chain is on the same network as the current service, movement of the document file between networks is unnecessary and Step 635 is bypassed.

Next, the URL of the final location where the document file is stored is provided to the next service in the workflow chain (640) and the next service is invoked (615). Document file URLs are transmitted in JavaScript Object Notation (JSON) format. The data container is a string array containing a URL endpoint to the document file. In some embodiments, the current service returns the URL of the initial location where the document file is stored to workflow chain management application 245, which either relays the returned URL to the next service, if the document file has not been moved, or provides a different URL of the final location where the document file is stored, if the document file has been moved. In some embodiments, the URL is provided to the next web service in conjunction with invoking EndpointLoad as part of initialization and preparatory work required by the next web service before being called.

Steps 615-640 are repeated iteratively until the current web service invoked at Step 615 is the output service, at which point the flow terminates.

Considering a specific example, a workflow chain may be constructed that includes a SCAN web service as the input service, an OCR web service as the input/output service and a STORE web service as the output service. When this workflow chain is executed, the SCAN service within local web services 243 causes scan engine 260 to scan a paper document on MFP 120 and produce a document image, which is stored in web service document files 244. The OCR service within local web services 243 then processes the document image and returns the processed document image to web service document files 244. The STORE service (e.g., store to GoogleDocs) hosted on remote web service server 150 then uploads the processed document image to remote web service document file database 160.

Taking another example, a workflow chain may be constructed that includes a SCAN web service as the input service, a PREVIEW web service as the input/output service and a PRINT web service as the output service. When the workflow chain is executed, the SCAN service within local web services 243 causes scan engine 260 to scan a paper document on MFP 120 to produce a document image, which is stored in web service document files 244. The PREVIEW service within local web services 243 then processes the document image and produces and displays a thumbnail image on front panel 210, which is stored in web service document files 244. The PRINT service within local web services 243 then causes print engine 250 to print a paper document on MFP 120 from the document image.

It will be appreciated by those of ordinary skill in the art that the invention can be embodied in other specific forms without departing from the spirit or essential character hereof. For example, while in the above embodiments the workflow chains are composed of document imaging web services and are configured and executed in an MFP environment, in other embodiments of the invention a workflow chain may be composed of object processing web services other than document imaging web services and may be configured and executed on or in conjunction with a computing device other than an MFP, such as a television, refrigerator, microwave, electronic advertising display panel, interactive presentation whiteboard or wireless handset.

The present description is considered in all respects to be illustrative and not restrictive. The scope of the invention is indicated by the appended claims, and all changes that come within the meaning and range of equivalents thereof are intended to be embraced therein.

What is claimed is:

1. A method for invoking a workflow chain of document imaging web services to process a document, comprising:
providing a catalog of a plurality of document imaging web services individually classified as input services, input/output services or output services;
constructing a workflow chain comprising a selected one of the input services, a selected one of the input/output services and a selected one of the output services; and
executing the workflow chain whereby the selected input service stores a first document file reflecting application of the input service to the document, the selected input/output service is provided a first reference to a first storage location of the first document file, locates the first document file using the first reference and stores a second document file reflecting application of the input/output service to the document, and the selected output service is provided a second reference to a second storage location of the second document file, locates the second document file using the second reference and is applied to the document.

2. The method of claim 1, wherein the configuring step is performed using user selections made on a workflow construction menu displaying a plurality of user-selectable options for input services, input/output services and output services.

3. The method of claim 1, further comprising:
determining whether a next one of the selected services is hosted on a different network than a current one of the selected services; and
moving a document file reflecting application of the current selected service to a storage location on the different network in response to determining that the next selected service is hosted on the different network.

4. The method of claim 3, wherein the current selected service is hosted on a secure private network and the next selected service is hosted on a public network.

5. The method of claim 3, wherein the current selected service is hosted on a public network and the next selected service is hosted on a secure private network.

6. The method of claim 1, wherein at least one of the selected services is hosted on a multifunction peripheral (MFP) and at least one of the selected services is hosted on a server remote from the MFP.

7. The method of claim 1, wherein the first and second references comprise Uniform Resource Locators (URLs).

8. The method of claim 1, wherein the cataloged input services comprise a document scanning service.

9. The method of claim 1, wherein the cataloged input services comprise a document retrieval service.

10. The method of claim 1, wherein the cataloged input/output services comprise an optical character recognition (OCR) service.

11. The method of claim 1, wherein the cataloged input/output services comprise a document preview service.

12. The method of claim 1, wherein the cataloged output services comprise a document printing service.

13. The method of claim 1, wherein the cataloged output services comprise a document storage service.

14. The method of claim 1, wherein the cataloged output services comprise a faxing service.

15. The method of claim 1, wherein the first reference and the second reference are the same.

16. The method of claim 1, wherein the first reference and the second reference are different.

17. The method of claim 1, wherein the first storage location and the second storage location are the same.

18. The method of claim 1, wherein the first storage location and the second storage location are different.

19. A system for invoking a workflow chain of document imaging web services to process a document, comprising:
a workflow construction subsystem configured to provide a catalog of a plurality of imaging web services individually classified as input services, input/output services or output services and construct a workflow chain comprising a selected one of the input services, a selected one of the input/output services and a selected one of the output services; and
a workflow execution subsystem operatively coupled with the workflow construction subsystem and configured to execute the workflow chain whereby the selected input service stores a first document file reflecting application of the input service to the document, the selected input/output service is provided a first reference to a first storage location of the first document file, locates the first document file using the first reference and stores a second document file reflecting application of the input/output service to the document, and the selected output service is provided a second reference to a second storage location of the second document file, locates the second document file using the second reference and is applied to the document.

20. A method for invoking a workflow chain of object processing web services to process an object, comprising:
providing a catalog of a plurality of object processing web services individually classified as input services, input/output services or output services;
constructing a workflow chain comprising a selected one of the input services, a selected one of the input/output services and a selected one of the output services; and
executing the workflow chain whereby the selected input service stores a first object reflecting application of the input service, the selected input/output service is provided a first reference to a first storage location of the first object, locates the first object using the first reference and stores a second object reflecting application of the input/output service, and the selected output service is provided a second reference to a second storage location of the second object, locates the second object using the second reference and is applied to the second object.
